(19) United States
(12) Patent Application Publication
(10) Pub. No.: US 2025/0130587 A1
(43) Pub. Date: Apr. 24, 2025

(54) METHODS AND APPARATUS TO DETERMINE ZONES FOR MACHINE OPERATION

(71) Applicant: Deere & Company, Moline, IL (US)

(72) Inventors: Ryan Kirk, Urbandale, IA (US); Mo Fotouhi, Madison, WI (US); Jared Grove, Saint Charles, IA (US); Matthew Burke, Denver, CO (US); Noel Wayne Anderson, Fargo, ND (US)

(21) Appl. No.: 18/764,982

(22) Filed: Jul. 5, 2024

Related U.S. Application Data
(60) Provisional application No. 63/591,831, filed on Oct. 20, 2023.

(51) Int. Cl. G05D 1/648; A01B 79/00; A01C 21/00; G05D 1/646; G05D 105/15

(52) U.S. Cl. CPC G05D 1/6482; A01B 79/005; A01C 21/005; G05D 1/646; G05D 2105/15

(57) ABSTRACT

Systems, apparatus, articles of manufacture, and methods are disclosed to determine a boundary for a work plan. An example apparatus includes circuitry to instantiate the machine-readable instructions to: detect a first attribute and a second attribute based on a characteristic of a plot of land, the first attribute corresponds to an uncertain feature in the plot of land; determine a first machine operation based on the first attribute and a second machine operation based on the second attribute; determine a first boundary around a first region, the first region including a first area of the plot of land including the first attribute; determine a second boundary around a second region, the second region including a second area of the plot of land including the second attribute; and determine a work plan based on the first boundary, the second boundary, and a relevance between the first attribute and the second attribute.

### RELATED APPLICATION

This patent claims the benefit of U.S. Provisional Patent Application No. 63/591,831, which was filed on Oct. 20, 2023. U.S. Provisional Patent Application No. 63/591,831 is hereby incorporated herein by reference in its entirety. Priority to U.S. Provisional Patent Application No. 63/591,831 is hereby claimed.

### FIELD OF THE DISCLOSURE

This disclosure relates generally to boundaries for machine operation and, more particularly, to methods and apparatus to determine zones for machine operation.

### BACKGROUND

In recent years, vehicles have become increasingly automated. As one example, agricultural vehicles may semi-autonomously or fully-autonomously drive and perform operations on plots of land. When driving and performing operations on plots of land, agricultural vehicles may receive maps to guide their path. Agricultural vehicles perform operations using implements including planting implements, spraying implements, harvesting implements, fertilizing implements, strip/till implements, etc. The control of these implements may be determined based on the position of the agricultural vehicle on the plot of land. These autonomous agricultural vehicles include multiple sensors to help navigate without assistance, or with limited assistance, from human users.

### BRIEF DESCRIPTION OF THE DRAWINGS

FIG. 1 is a block diagram of an example environment in which an example vehicle operates according to boundaries.

FIG. 2 is an example circuitry diagram of the example server of FIG. 1.

FIG. 3 is a block diagram representative of an example data flow structured to execute, instantiate, and/or perform the example machine-readable instructions to implement the subzone boundary creation circuitry of FIG. 2.

FIG. 4 is a diagram representative of a first example subzone boundary as generated in FIG. 2.

FIG. 5 is a diagram representative of a second example subzone boundary as generated in FIG. 2.

FIG. 6 is a diagram representative of example subzones generated by the subzone boundary creation circuitry of FIG. 2.

FIG. 7 is a diagram representative of a first example vehicle operation using the subzone boundary creation circuitry of FIG. 2.

FIG. 8 is a diagram representative of a second example vehicle operation using the subzone boundary creation circuitry of FIG. 2.

FIG. 9 is a flowchart representative of example machine-readable instructions and/or example operations that may be executed, instantiated, and/or performed by example programmable circuitry to implement the subzone boundary creation circuitry of FIG. 2.

FIG. 10 is a flowchart representative of example machine-readable instructions and/or example operations that may be executed, instantiated, and/or performed by example programmable circuitry to implement the determination of subzones and values of FIG. 9.

FIG. 11 is a flowchart representative of example machine-readable instructions and/or example operations that may be executed, instantiated, and/or performed by example programmable circuitry to implement the detection of first subzones of FIG. 10.

FIG. 12 is a flowchart representative of example machine-readable instructions and/or example operations that may be executed, instantiated, and/or performed by example programmable circuitry to implement the prescription of field operations based on determined values of subzones of FIG. 9.

FIG. 13 is a flowchart representative of example machine-readable instructions and/or example operations that may be executed, instantiated, and/or performed by example programmable circuitry to implement the generation of boundaries around subzones of FIG. 9.

FIG. 14 is a block diagram of an example processing platform including programmable circuitry structured to execute, instantiate, and/or perform the example machine-readable instructions and/or perform the example operations of FIGS. 9-13 to implement the subzone boundary creation circuitry of FIG. 2.

FIG. 15 is a block diagram of an example implementation of the programmable circuitry of FIG. 14.

FIG. 16 is a block diagram of another example implementation of the programmable circuitry of FIG. 14.

FIG. 17 is a block diagram of an example software/firmware/instructions distribution platform (e.g., one or more servers) to distribute software, instructions, and/or firmware (e.g., corresponding to the example machine-readable instructions of FIGS. 9-13) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Automation of vehicles is desired. Such vehicle automation improves the accuracy of the performance of operations, reduces operator fatigue, improves efficiency, and accrues other benefits. In particular, the automation of agricultural vehicles has beneficial secondary effects such as efficiency of agricultural operations and/or precise placement of agricultural material.

The automation of vehicles across a plot of land having different conditions, requirements, or operations, requires boundaries that dictate the travel and operation of the vehicle throughout subzones. As discussed herein, a boundary is a border between adjacent regions of a plot of land, wherein the regions encompassed by the boundaries are subzones. One type of subzone is an exclusion zone in which the vehicle may not perform any, or may only perform a certain, agricultural operation(s). Exclusion zones may be fixed and applied to all operations. In other examples, exclusion zones may only apply to certain activities, like tillage, and allow other activities, like traversal. Some exclusion zones are temporary, such as when the field is too muddy to permit traversal and are removed when the plot of land dries.

While the creation of boundaries and subzones for machine operation is highly advantageous, current methods are burdensome as the boundaries are created from tabular geospatial data. However, working with tabular geospatial data is challenging. First, tabular geospatial data contains numerous redundant data points that make the dataset large and difficult to manage. Second, transferring large tabular datasets is time-consuming, especially when dealing with remote teams or clients. Third, visualization of an entire tabular geospatial data set, which is necessary to help detect patterns, relationships, and trends, is very difficult. Lastly, tabular datasets are costly to store and process.

The boundaries come from a variety of sources. These boundaries can be hand-drawn (e.g., using mapping software), machine-generated, algorithmically developed (e.g., based on historical travel paths), etc. Consequently, a process to combine existing boundaries is necessary. Then, during combination, confidence in a boundary determines when a plot of land is ready for automation. Conventional boundary combination methods can combine boundaries but are unable to express a confidence in each boundary during combination.

The boundaries define subzones and exclusion zones.

Conventional subzones for vehicle operation rely on a method where the vehicle is controlled to perform a certain operation while traveling between each boundary. In doing so, the presence of hazards or natural obstacles is difficult to detect and account for in an autonomous operation. Conventional subzones do not account for areas where the actual boundary of the plot of land is uncertain in a region. In areas where the boundary is uncertain, the operator of the vehicle must use a judgment call of where to travel. Uncertainty of a boundary may arise from discrepancies between data from outside sources (e.g., map data, satellite data, etc.) and the actual conditions of the specific plot of land. Example conditions giving rise to regions of interest for placement of a boundary include regions of a plot of land with characteristics that will result in poor outcomes (poor soil, low moisture, etc.), natural obstacles (trees, streams, steep slopes, etc.), trial zones, and hazards (such as, spraying in residential areas, etc.).

The examples disclosed herein allow for compression of tabular geospatial data sets to analyze a plot of land and produce a set of geospatial features that correspond to the plot of land. As used herein, a plot of land refers to a portion of land about which the user wishes to obtain information, data sets, boundaries, etc. Then, this set of geospatial features is used to generate subzones within which machine operations (e.g., machine travel, agricultural operations, etc.) are assigned. After assignment of machine operations, an autonomous vehicle can navigate the plot of land performing the assigned machine operations per each subzone.

Along with other sources of data, generated subzones may be used to generate a soft boundary. As used herein, a soft boundary is a probabilistic boundary. This probabilistic boundary may be created from a combination of existing boundaries from different sources with weighted confidences to return a combined boundary. As a result of the combination, each point along the combined boundary has a distribution of possible locations.

The disclosed systems and methods address issues of the conventional approaches. Particularly, the solution herein allows for the creation of exclusion zones where machine operation is not necessary, but still accounted for, in the plot of land.

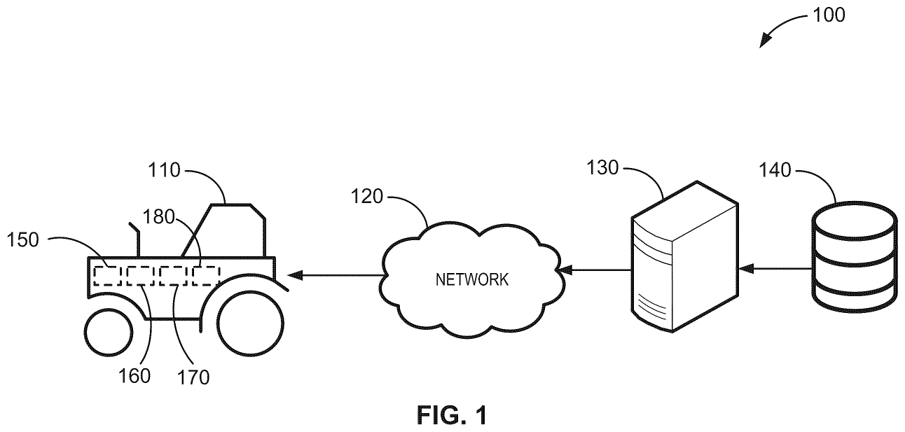

FIG. 1 is a block diagram of an example operational environment 100. An example vehicle 110 is in communication with a network 120, which is also in communication with one or more servers 130. The server 130 utilizes one or more databases 140 to store information used to determine boundaries. In one example, the server 130 accesses information from the database 140 and determines one or more boundaries, subzones, and/or exclusion zones, which are communicated through the network to the vehicle 110.

As shown in the example of FIG. 1, the vehicle 110 includes an example position determination system 150, an example navigation system 160, an example data store 170, and an example communication system 180. The communication system 180 receives the boundary information from the server 130 via the network 120 and stores the same in the data store 170. In some examples, data collected by the position determining system 150 may be sent back to the server 130 via the network 120. The navigation system 160, which may include an automated driving functionality, controls navigation of the vehicle 110 in accordance with the information in the data store 170, including boundaries, subzones, exclusion zones, etc. Thus, the vehicle operations are controlled in accordance with the boundaries generated by the server 130.

The example vehicle 110 of FIG. 1 may be an agricultural vehicle (e.g., a tractor, a front loader, a harvester, a cultivator, a mower, or any other suitable vehicle), a construction vehicle, a forestry vehicle, or other work vehicle. In the example of FIG. 1, the vehicle 110 is represented as a tractor; however, other vehicles may additionally or alternatively be included. The vehicle 110 can move between different locations and over different terrain.

The example network 120 of FIG. 1 shuttles communication between the server 130 and the example vehicle 110. The example network 120 may be implemented by wireless communication, satellite communication, or other suitable communication modes.

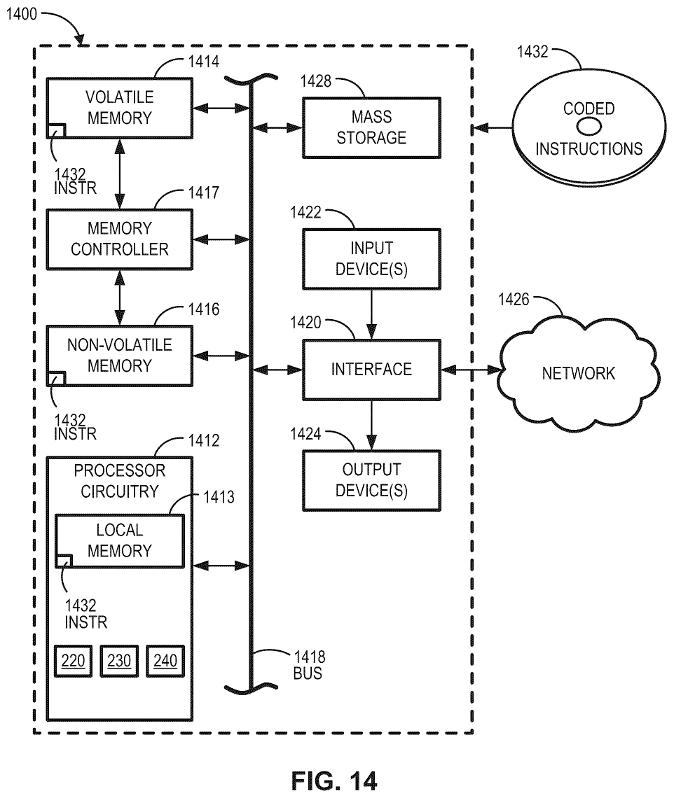

The example server 130 of FIG. 1 may be instantiated, implemented, or performed as described in connection with the processor circuitry of FIGS. 14-17.

The example database 140 of FIG. 1 stores information concerning plots of land, machine operations, etc., for use by the server 130. The example database 140 may be implemented by magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

While in the example of FIG. 1, the server 130 and the database 140 are shown separate from the vehicle 110, in other examples the functionality described herein as associated with the server may be implemented within the vehicle 110. For example, the vehicle 110 may be equipped with processing power, such as a server, and data storage, such as a database, to implement the functions associated with the server 130 and the database 140 described herein.

In FIG. 1, the example position determination system 150 may be a GNSS receiver included in the vehicle 110. This example position determination system 150 may be equipped with Global Navigation Satellite System (GNSS), Global Positioning Systems (GPS), Light Detection and Ranging (LIDAR), Radio Detection and Ranging (RADAR), Sound Navigation and Ranging (SONAR), telematics sensors, etc. In some examples, the example GNSS receiver may use differential correction such as (a) precise point positioning (PPP) mode or wide area augmentation, or (b) RTK (real time kinematic) mode. The RTK system or mode requires at least one local base station that provides correction information wirelessly to the GNSS receiver with a wireless communications device that can receive correction data from the local base station in RTK. Similarly, for the GNSS receiver operating as PPP or PPP mode has a network of reference GNSS stations at known locations that provide a correction signal to the GNSS receiver on the vehicle 110 via a wireless communications device, such as satellite communications device. In some examples, this position determination system 150 may be connected to a central server (e.g., John Deere Operations Center “OpsCenter”, server 130 of FIG. 1, etc.) where collected boundary data and collected subzone data are stored from past operations on that plot of land. Each time the same plot of land has equipment travel over the land or perform an operation on that land, such as tilling, planting, spraying, harvesting, or performing other work tasks, boundary data is collected to be stored in the database 140 for use in successive agricultural operations.

The navigation system 160 receives, processes, and transmits example instructions to control operation of the vehicle 110. The navigation system 160 may also receive instructions to perform various machine operations such as, tilling, planting, spraying, harvesting, or other work tasks. Additionally or alternatively, the navigation system 160 may transmit information of the terrain and machine operation performed for a specific plot of land to the server 130.

The data store 170 receives, processes, and transmits example instructions from the server 130. The data store 170 may be a memory, and store instructions for later or contemporary use by the vehicle 110. The instructions contained in the data store 170 may correspond to vehicle operation instructions and/or collected data from the plot of land.

The communication system 180 receives, processes, and transmits example instructions from the server 130 to the data store 170 and the navigation system 160. The communication system 180 may communicate instructions concerning boundaries, maps, sensor data, etc. The communication system may be implemented as a wireless system, a cellular system, a satellite system, a radio system, etc.

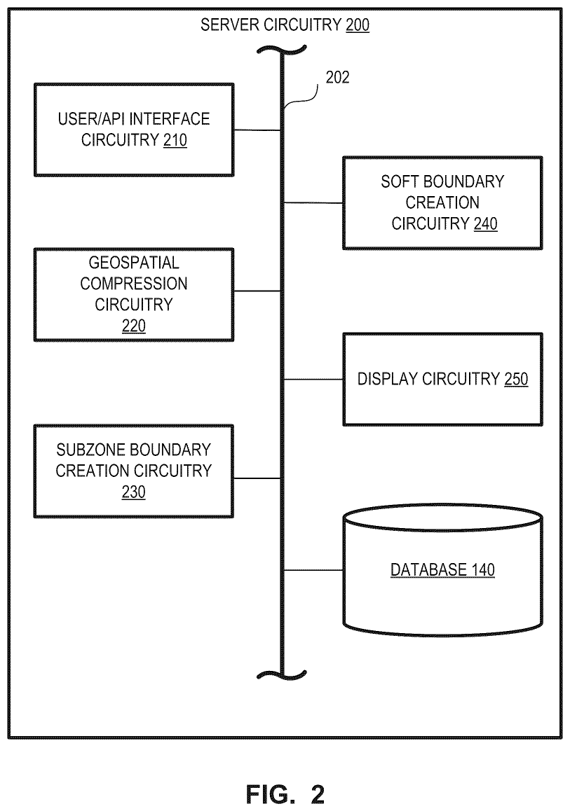

FIG. 2 is a block diagram representative of example server circuitry 200 to implement the server 130 of FIG. 1. The components of the example server circuitry 200 are connected by an example bus 202. The user/API interface circuitry 210 receives a user request for compressed data and/or boundaries/subzones within a plot of land. The geospatial compression circuitry 220 compresses the data for use in later implementations and may extract features for a requested plot of land. The subzone boundary creation circuitry 230 may use the compressed data, uncompressed data, or the set of geospatial features to detect differing values (e.g., subzones) within the dataset to prescribe differing machine operations based on the detected values. The soft boundary creation circuitry 240 generates soft boundaries for use in applications such as subzone detection and other boundary applications. The soft boundary creation circuitry 240 may use compressed data from the geospatial compression circuitry and/or uncompressed data from another source. Additionally or alternatively, the soft boundary creation circuitry 240 may generate soft boundaries to be used by the subzone boundary creation circuitry 230. Upon generation of a compressed data set, a set of geospatial features, a subzone, or a soft boundary, the display circuitry 250 may display the result. Lastly, the compressed data set, the set of geospatial features, the subzone, or the soft boundary may be stored in the database 140.

It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example server 130 of FIG. 1 may be instantiated (e.g., creating an instance of, bring into being for any length of time, materialize, implement, etc.) by programmable circuitry such as a Central Processor Unit (CPU) executing first instructions. Additionally or alternatively, the example server 130 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

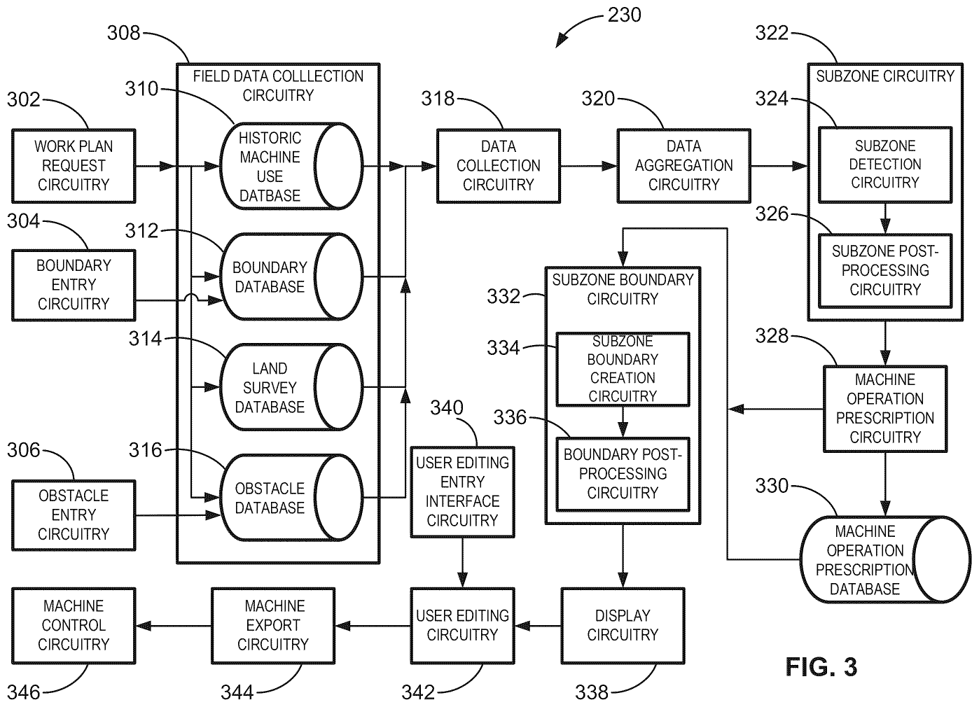

FIG. 3 is a block diagram representative of an example implementation of the server 130 of FIG. 1 to implement the subzone boundary creation circuitry 230 of FIG. 2. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

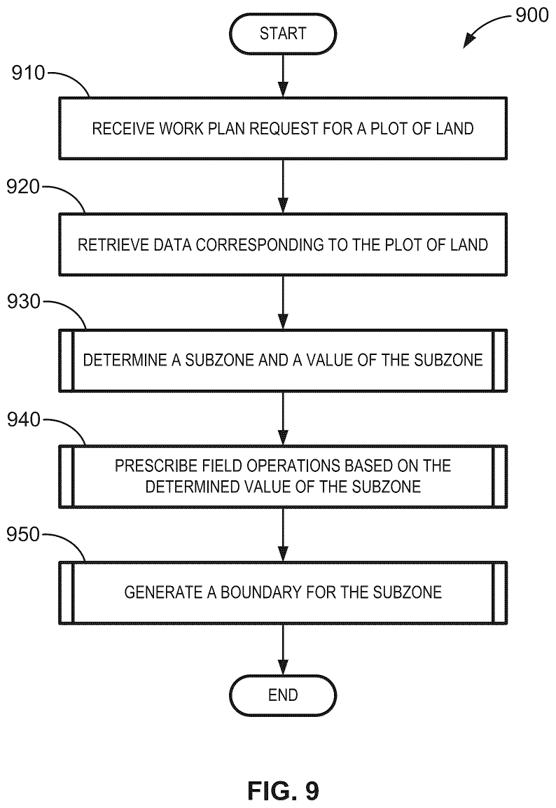

The process of FIG. 3 begins with a request for a work plan received by work plan request circuitry 302. The work plan may be a user created or an automatically generated plan for work of a specific type of machine operation (planting, harvesting, grading, excavating, etc.) on a specific plot of land (field, jobsite, etc.) entered into a web or mobile application. The work plan may include basic operation prescriptions for the entire piece of land. Additionally or alternatively, the work plan may be inputted through a web or mobile application interface (e.g., the work plan request circuitry 302) to receive the work plan and make a request for data relevant to the work plan. In some examples, the work plan request circuitry 302 is instantiated, in part, by programmable circuitry executing work plan request instructions and/or configured to perform operations such as those represented by the flowchart of FIG. 9 (block 910).

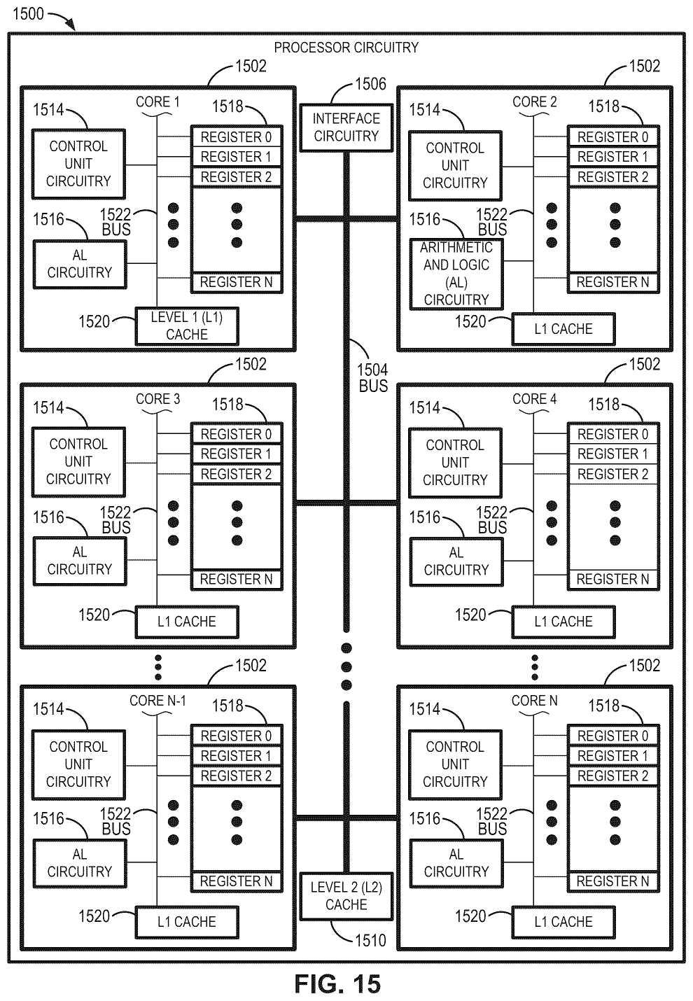

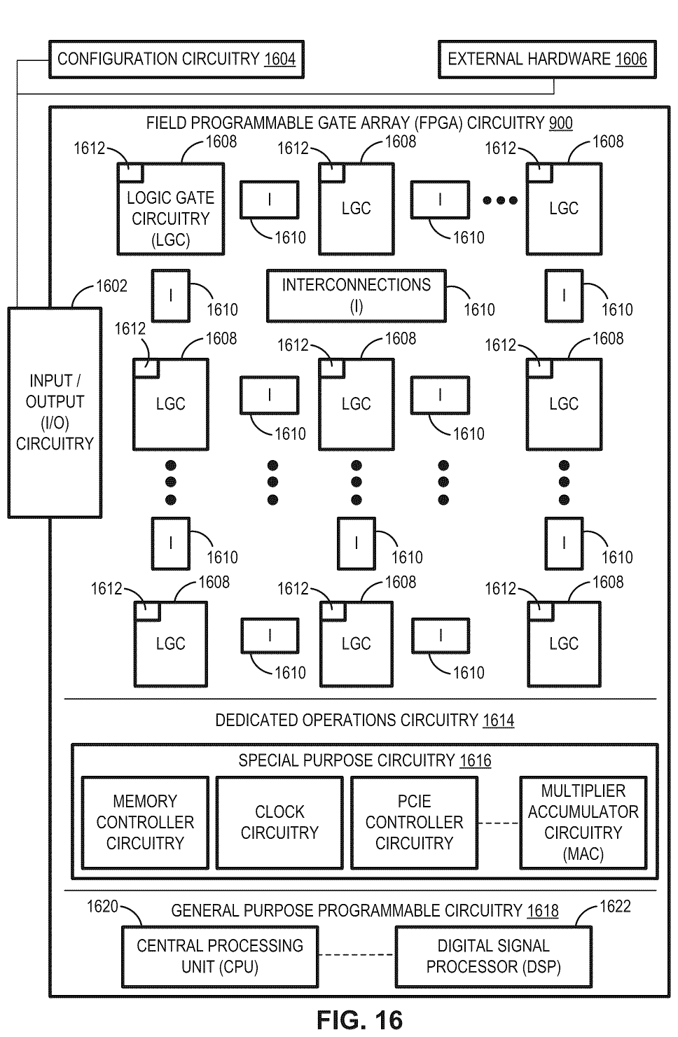

In some examples, the subzone boundary creation circuitry 230 includes means for receiving a request for a work plan. For example, the means for receiving the request for the work plan may be implemented by work plan request circuitry 302. In some examples, the work plan request circuitry 302 may be instantiated by programmable circuitry such as the example programmable circuitry 1412 of FIG. 14. For instance, the work plan request circuitry 302 may be instantiated by the example microprocessor 1500 of FIG. 15 executing machine executable instructions such as those implemented by at least block 910 of FIG. 9. In some examples, the work plan request circuitry 302 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the work plan request circuitry 302 may be instantiated by any other combination of hardware, software, and/or firmware. For example, the work plan request circuitry 302 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

After a work plan request is made, the field data collection circuitry 308 gathers data to fulfill the work plan request from a variety of databases. These databases include the historic machine use database 310, the boundary database 312, the land survey database 314, and the obstacle database 316. The field data collection circuitry 308 then sends the data pulled from the databases (310, 312, 314, and 316) to data collection circuitry 318. In some examples, the field data collection circuitry 308, historic machine use database 310, the boundary database 312, the land survey database 314, and the obstacle database 316, are instantiated, in part, by programmable circuitry executing field data collection instructions and/or configured to perform operations such as those represented by the flowchart of FIG. 9 (block 920).

In some examples, the subzone boundary creation circuitry 230 includes means for gathering data to fulfill the work plan request. For example, the means for gathering the data to fulfill the work plan request may be implemented by field data collection circuitry 308. In some examples, the field data collection circuitry 308 may be instantiated by programmable circuitry such as the example programmable circuitry 1412 of FIG. 14. For instance, the field data collection circuitry 308 may be instantiated by the example microprocessor 1500 of FIG. 15 executing machine executable instructions such as those implemented by at least block 920 of FIG. 9. In some examples, the field data collection circuitry 308 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the field data collection circuitry 308 may be instantiated by any other combination of hardware, software, and/or firmware. For example, the field data collection circuitry 308 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The historic machine use database 310 contains information about the historic use of machines in the specified land area. The historic machine database 310 may contain operational values such as location, speed traveled, and outcomes (e.g., yield, seeding rate, spraying rate, etc.).

The boundary database 312 contains information about existing boundaries for the specified area of land and the geospatial location of the plot of land. Geospatial location of the plot of land corresponds to georeferenced coordinates. Georeferenced coordinates may include a global coordinate system and/or a local coordinate system. In some examples, georeferenced coordinates may include latitude and longitude coordinates. The boundary database 312 may include information about existing interior and exterior boundaries of the land area (e.g., boundaries for the plot of land). Additionally or alternatively, the boundary database 312 may receive boundaries from boundary entry circuitry 304. The boundary entry circuitry 304 enters information about a boundary in the plot of land to the obstacle database 312. The boundary entry circuitry 304 may be a web or mobile application that allows boundaries to be saved and included during the sub-zone creation process. Further, the boundary entry circuitry 304 may be instantiated by an interface for a user to enter boundaries. In some examples, the boundary entry circuitry 304 is instantiated, in part, by programmable circuitry executing boundary entry instructions and/or configured to perform operations such as those represented by the flowchart of FIG. 9 (block 920).

In some examples, the subzone boundary creation circuitry 230 includes means for entering information about a boundary in a plot of land. For example, the means for entering information about the boundary in the plot of land may be implemented by boundary entry circuitry 304. In some examples, the boundary entry circuitry 304 may be instantiated by programmable circuitry such as the example programmable circuitry 1412 of FIG. 14. For instance, the boundary entry circuitry 304 may be instantiated by the example microprocessor 1500 of FIG. 15 executing machine executable instructions such as those implemented by at least block 920 of FIG. 9. In some examples, the boundary entry circuitry 304 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the boundary entry circuitry 304 may be instantiated by any other combination of hardware, software, and/or firmware. For example, the boundary entry circuitry 304 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The land survey database 314 contains information about land surveys for the specific area of land. The land survey information may come from an internal source, external source, or both. The land survey information may contain variables such as soil type, soil moisture, surveyed elevation, surveyed boundaries, etc. Land survey information may come from terrestrial sensing or remote sensing sources.

The obstacle database 316 contains information for boundaries around obstacles within a land area. This information may include boundaries around objects such as irrigation equipment, trees, rocks, ditches, terraces, bodies of water, etc. Some obstacles may be persistent while others are transitory. Additionally or alternatively, the obstacle database 316 may receive information from the obstacle entry circuitry 306. In some examples, a user may enter information about an obstacle in a plot of land via the obstacle entry circuitry 306. The boundary may be received by the obstacle entry circuitry 306 for entry into the obstacle database 316 and/or used in the process of generating subzones. Boundaries entered into the obstacle database 316 may come from an automatically generated process (e.g., OpsCenter Boundary Creator), manually drawn on a web or mobile application (e.g., draw a boundary on OpsCenter), uploaded from a mobile or machine display (e.g., boundaries from Gen4 Display), uploaded from an external source (e.g., a USB drive), etc. In some examples, the obstacle entry circuitry 306 is instantiated, in part, by programmable circuitry executing obstacle entry instructions and/or configured to perform operations such as those represented by the flowchart of FIG. 9 (block 920).

In some examples, the subzone boundary creation circuitry 230 includes means for entering information about an obstacle in a plot of land. For example, the means for entering information about the obstacle in the plot of land may be implemented by obstacle entry circuitry 306. In some examples, the obstacle entry circuitry 306 may be instantiated by programmable circuitry such as the example programmable circuitry 1412 of FIG. 14. For instance, the obstacle entry circuitry 306 may be instantiated by the example microprocessor 1500 of FIG. 15 executing machine executable instructions such as those implemented by at least block 920 of FIG. 9. In some examples, the obstacle entry circuitry 306 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the obstacle entry circuitry 306 may be instantiated by any other combination of hardware, software, and/or firmware. For example, the obstacle entry circuitry 306 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

These example databases 310, 312, 314, and 316, may be one or more mass storage discs or devices to store firmware, software, and/or data. Examples of such mass storage discs or devices 310, 312, 314, and 316, include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The data collection circuitry 318 receives the work plan request for a specific machine or set of machines corresponding to a specific piece of land, and collects the available, relevant information from the field data collection circuitry 308. After the work plan and available information for the plot of land is collected, the data collection circuitry 318 sends this information to the data aggregation circuitry 320. In some examples, the data collection circuitry 318 is instantiated, in part, by programmable circuitry executing data collection instructions and/or configured to perform operations such as those represented by the flowchart of FIG. 9 (block 920).

In some examples, the subzone boundary creation circuitry 230 includes means for collecting information relevant to a work plan request. For example, the means for collecting information relevant to the work plan request may be implemented by data collection circuitry 318. In some examples, the data collection circuitry 318 may be instantiated by programmable circuitry such as the example programmable circuitry 1412 of FIG. 14. For instance, the data collection circuitry 318 may be instantiated by the example microprocessor 1500 of FIG. 15 executing machine executable instructions such as those implemented by at least block 920 of FIG. 9. In some examples, the data collection circuitry 318 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the data collection circuitry 318 may be instantiated by any other combination of hardware, software, and/or firmware. For example, the data collection circuitry 318 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

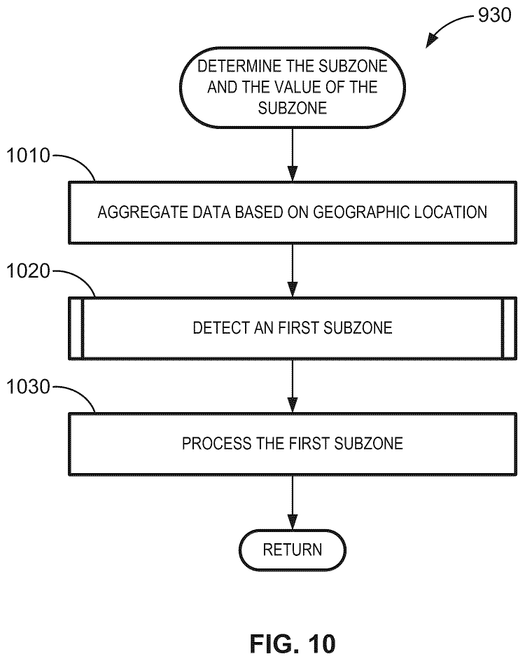

The data aggregation circuitry 320 receives data for the plot of land of the work plan request and aggregates the data based on geographic location. The technique of aggregation applied by the data aggregation circuitry 320 may differ based on the data for the plot of land. The data aggregation circuitry 320 may find mean, median, mode, or some weighted sum of values in some sort of geospatial bucket (e.g., hex-index, quad-key). Additionally or alternatively, the data aggregation circuitry 320 may convert the original or bucketed data into an alternative form (e.g., a graph/network representation). Additionally or alternatively, the data aggregation circuitry 320, based on the identity of the variable, may pass the data directly through to the subzone circuitry 322 (e.g., may not perform aggregation on data). In some examples, the data aggregation circuitry 320 is instantiated, in part, by programmable circuitry executing data aggregation instructions and/or configured to perform operations such as those represented by the flowchart of FIG. 10 (block 1010).

In some examples, the subzone boundary creation circuitry 230 includes means for aggregating data based on geographic location. For example, the means for aggregating data based on geographic location may be implemented by data aggregation circuitry 320. In some examples, the data aggregation circuitry 320 may be instantiated by programmable circuitry such as the example programmable circuitry 1412 of FIG. 14. For instance, the data aggregation circuitry 320 may be instantiated by the example microprocessor 1500 of FIG. 15 executing machine executable instructions such as those implemented by at least block 1010 of FIG. 10. In some examples, the data aggregation circuitry 320 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the data aggregation circuitry 320 may be instantiated by any other combination of hardware, software, and/or firmware. For example, the data aggregation circuitry 320 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The subzone circuitry 322 receives the aggregated data from the data aggregation circuitry 320 to proceed with subzone detection.

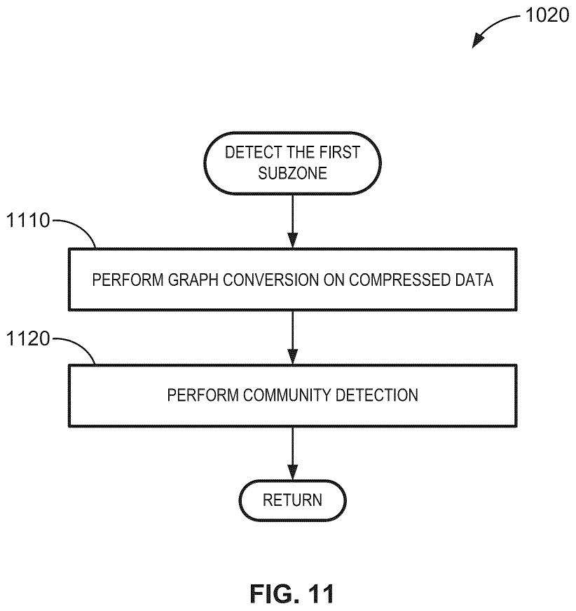

First, the subzone circuitry 322 directs the data to the subzone detection circuitry 324. The subzone detection circuitry 324 performs subzone detection on the data. Subzone detection may be performed using one or many techniques. These techniques may include graph-based community detection methods (e.g. graph algorithms), flood fill methods, data-based methods (e.g., Birch, DBScan, k-means), alternative data representation methods, etc. In some examples, the subzone detection circuitry 324 may perform graph conversion on compressed data. After performing graph conversion on the compressed data, the subzone detection circuitry 324 performs community detection to detect subzones within the converted graph data. Detection of these subzones may be performed for differing agronomic conditions of the plot of land. These techniques may be done in a streaming fashion or on the whole data set at once, depending on the technique employed. The subzones may be detected based on features analyzed simultaneously or separately. The first subzones are then passed to the subzone post-processing circuitry 326. In some examples, the subzone detection circuitry 324 is instantiated, in part, by programmable circuitry executing subzone detection instructions and/or configured to perform operations such as those represented by the flowcharts of FIG. 10 (block 1020) and FIG. 11.

In some examples, the subzone boundary creation circuitry 230 includes means for detecting subzones from data for a plot of land. For example, the means for detecting subzones from the data for the plot of land may be implemented by subzone detection circuitry 324. In some examples, the subzone detection circuitry 324 may be instantiated by programmable circuitry such as the example programmable circuitry 1412 of FIG. 14. For instance, the subzone detection circuitry 324 may be instantiated by the example microprocessor 1500 of FIG. 15 executing machine executable instructions such as those implemented by at least block 1020 of FIG. 10 and blocks 1110 and 1120 of FIG. 11. In some examples, the subzone detection circuitry 324 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the subzone detection circuitry 324 may be instantiated by any other combination of hardware, software, and/or firmware. For example, the subzone detection circuitry 324 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The subzone post-processing circuitry 326 receives the first subzones from the subzone detection circuitry 324 and applies an additional layer of processing. The additional layer of processing may include operations such as combining adjacent subzones that have average values within a tolerance range. Further, the combination of adjacent subzones may be applied when the subzones are created using techniques that have adjacency information. The additional layer of processing may include removing subzones with values at the expected level that do not provide any operationally useful insights (e.g., subzones that represent a standard condition for the plot of land, etc.), and/or combining subzones across variables/features to generate specific subzones. In some examples, subzones may be removed if they are smaller than an area threshold or have a linear dimension shorter than a length threshold, a depth threshold, or a height threshold. After post-processing by the subzone post-processing circuitry 326, the subzones are sent to the machine operation prescription circuitry 328. In some examples, the subzone post-processing circuitry 326 is instantiated, in part, by programmable circuitry executing subzone post-processing instructions and/or configured to perform operations such as those represented by the flowchart of FIG. 10 (block 1030).

In some examples, the subzone boundary creation circuitry 230 includes means for applying an additional layer of processing to subzones. For example, the means for applying the additional layer of processing to the subzones may be implemented by subzone post-processing circuitry 326. In some examples, the subzone post-processing circuitry 326 may be instantiated by programmable circuitry such as the example programmable circuitry 1412 of FIG. 14. For instance, the subzone post-processing circuitry 326 may be instantiated by the example microprocessor 1500 of FIG. 15 executing machine executable instructions such as those implemented by at least block 1030 of FIG. 10. In some examples, the subzone post-processing circuitry 326 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the subzone post-processing circuitry 326 may be instantiated by any other combination of hardware, software, and/or firmware. For example, the subzone post-processing circuitry 326 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

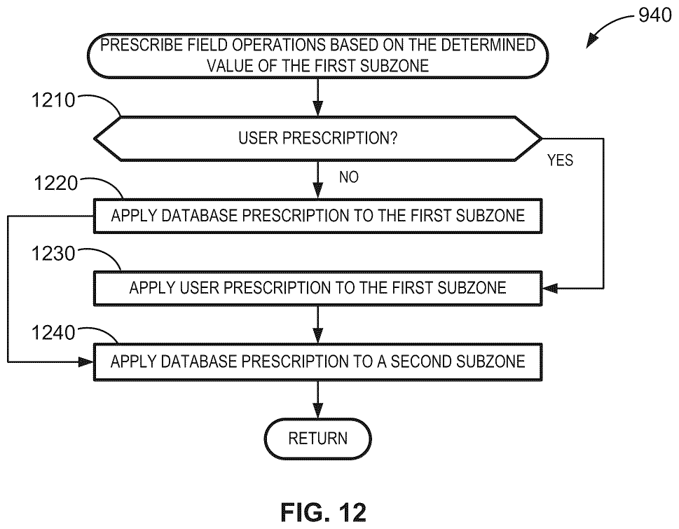

The machine operation prescription circuitry 328 analyzes a data cluster for a land area that was found during subzone detection and prescribes a machine operation to the subzone. The machine operation may be received from an interface (e.g., a machine operation prescription interface). This interface may be a web or mobile application where a machine operation prescription is entered (e.g., by a user, etc.). The prescription received from the interface may be saved to the machine operation prescription database 330. In some examples, the machine operation prescription circuitry 328 may be automated with varying degrees of human input and supervision. In some examples, the machine operation prescription circuitry 328 prescribes to the machine operation to the subzone based on a default prescription from the machine operation prescription database 330. The default prescription may be based on the data used to generate the subzone, the geographic location of the subzone, etc. Further, in some examples, the machine operation is prescribed based on a determined value of the subzone. The value of the subzone to correspond to a characteristic of the subzone (e.g., terrain, geographic location, historic use, etc.). Once the subzone is assigned the machine operation, control proceeds to the subzone boundary circuitry 332. In some examples, the machine operation prescription circuitry 328 and machine operation prescription database 330 is instantiated, in part, by programmable circuitry executing machine operation prescription instructions and/or configured to perform operations such as those represented by the flowchart of FIG. 12, respectively.

In some examples, the subzone boundary creation circuitry 230 includes means for prescribing a machine operation to a subzone. For example, the means for prescribing the machine operation to the subzone may be implemented by machine operation prescription circuitry 328. In some examples, the machine operation prescription circuitry 328 may be instantiated by programmable circuitry such as the example programmable circuitry 1412 of FIG. 14. For instance, the machine operation prescription circuitry 328 may be instantiated by the example microprocessor 1500 of FIG. 15 executing machine executable instructions such as those implemented by at least blocks 1210-1240 of FIG. 12. In some examples, the machine operation prescription circuitry 328 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the machine operation prescription circuitry 328 may be instantiated by any other combination of hardware, software, and/or firmware. For example, the machine operation prescription circuitry 328 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The subzone boundary circuitry 332 receives subzones and assigned operations. The subzone boundary circuitry 332 includes subzone boundary creation circuitry 334 and boundary post-processing circuitry 336.

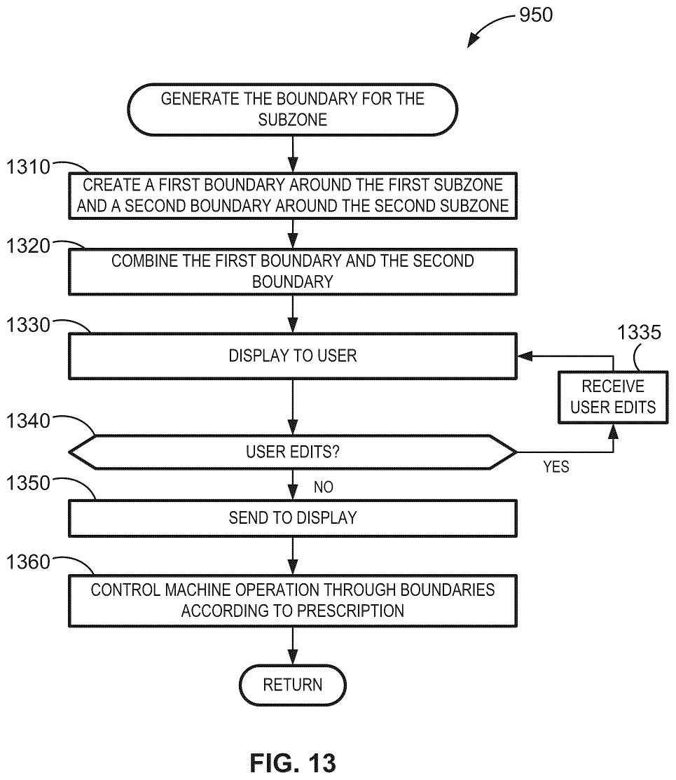

The subzone boundary creation circuitry 334 creates a boundary around each of the subzones and assigns the prescriptions to the boundaries. This boundary creation process may be a procedural method that creates a traditional boundary (such as a convex or concave hull) or a soft boundary around a subzone. The boundary around the subzone signals to the machine performing an agricultural operation where to begin and end the agricultural operation (e.g., the prescriptions to the boundaries, etc.) and/or when to begin another agricultural operation. In some examples, the subzone boundary creation circuitry 334 is instantiated, in part, by programmable circuitry executing subzone boundary creation instructions and/or configured to perform operations such as those represented by the flowchart of FIG. 13 (block 1310).

In some examples, the subzone boundary creation circuitry 230 includes means for creating a boundary around a subzone and prescribing a machine operation to the boundary. For example, the means for creating a boundary around the subzone and prescribing the machine operation to the boundary may be implemented by subzone boundary creation circuitry 334. In some examples, the subzone boundary creation circuitry 334 may be instantiated by programmable circuitry such as the example programmable circuitry 1412 of FIG. 14. For instance, the subzone boundary creation circuitry 334 may be instantiated by the example microprocessor 1500 of FIG. 15 executing machine executable instructions such as those implemented by at least block 1310 of FIG. 13. In some examples, the subzone boundary creation circuitry 334 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the subzone boundary creation circuitry 334 may be instantiated by any other combination of hardware, software, and/or firmware. For example, the subzone boundary creation circuitry 334 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The boundaries are then sent to the boundary post-processing circuitry 336. The boundary post-processing circuitry 336 analyzes the boundaries for relevance. The boundary post-processing circuitry 336 may combine boundaries that are adjacent to each other (e.g. when the boundaries are close in value). In some examples, two subzones with a true common boundary may be independently created, but the true common boundary may have different numeric values (e.g., georeferenced coordinates, latitude and longitude values) arising from how the subzones were originally defined (e.g., traversing the boundary of each subzone with a GNSS receiver at different times). Combination of close boundaries may be particularly useful for subzone detection methods that do not retain adjacency information. Additionally, boundaries may be removed that do not have operational significance. These boundaries may be the standard parts of the plot of land as opposed to areas with obstacles or aberrations from normal operation. Then, the boundary post-processing circuitry 336 combines the boundary information together into a single object. This single object may be a single multi-polygon or other method of representing geospatial polygons. Then, this polygon is associated with the machine operations and prepared to be displayed. In some examples, the boundary post-processing circuitry 336 is instantiated, in part, by programmable circuitry executing boundary post-processing instructions and/or configured to perform operations such as those represented by the flowchart of FIG. 13 (block 1320).

In some examples, the subzone boundary creation circuitry 230 includes means for analyzing a boundary for relevance. For example, the means for analyzing the boundary for relevance may be implemented by boundary post-processing circuitry 336. In some examples, the boundary post-processing circuitry 336 be instantiated by programmable circuitry such as the example programmable circuitry 1412 of FIG. 14. For instance, the boundary post-processing circuitry 336 may be instantiated by the example microprocessor 1500 of FIG. 15 executing machine executable instructions such as those implemented by at least block 1320 of FIG. 13. In some examples, the boundary post-processing circuitry 336 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the boundary post-processing circuitry 336 may be instantiated by any other combination of hardware, software, and/or firmware. For example, the boundary post-processing circuitry 336 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

Then, the processed boundary is displayed by the display circuitry 338. The display circuitry 338 receives the boundaries (e.g., multi-polygon object) and operation values, formats them to be displayed on a web/mobile application, and displays the boundaries. The boundaries may be displayed on a map of the land area. Further, the operations may be visualized with the boundaries. For example, the display circuitry 338 may display the operations when a cursor hovers over a boundary or an area within the boundary (e.g., within the subzone corresponding to the boundary). In another example, the display circuitry 338 may display the operations as text within the associated boundary. In another example, the display circuitry 338 may display the operations as shades of color in the area within the boundary and a legend to the side of the display to guide interpretation of the colors. Additionally or alternatively, the display circuitry 338 may receive input from user editing circuitry 342, and may format the edits and selectively update parts of the displayed information to show the user selected edits. In some examples, the display circuitry 338 is instantiated, in part, by programmable circuitry executing display instructions and/or configured to perform operations such as those represented by the flowchart of FIG. 13 (block 1330).

In some examples, the subzone boundary creation circuitry 230 includes means for displaying a boundary. For example, the means for displaying the boundary may be implemented by display circuitry 338. In some examples, the display circuitry 338 be instantiated by programmable circuitry such as the example programmable circuitry 1412 of FIG. 14. For instance, the display circuitry 338 may be instantiated by the example microprocessor 1500 of FIG. 15 executing machine executable instructions such as those implemented by at least block 1330 of FIG. 13. In some examples, the display circuitry 338 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the display circuitry 338 may be instantiated by any other combination of hardware, software, and/or firmware. For example, the display circuitry 338 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

A user may enter edits to the boundaries and machine operations via the user editing circuitry 342. The edits may be received from a user editing entry interface circuitry 340. The user editing entry interface circuitry 340 may be a part of a web or mobile application that allows a user to make edits to an existing set of boundaries and operations. The user may edit the existing set of boundaries and operations using an editing screen to delete or add boundaries and change the operation values. Then, the user may have the option of saving these edited values for future use in the machine operation prescription database 330. These edits may be displayed via the display circuitry 338 for further user visualization and either accepted, rejected, or further edited by the user. In some examples, the user editing entry interface circuitry 340 and the user editing circuitry 342 are instantiated, in part, by programmable circuitry executing user edit instructions and/or configured to perform operations such as those represented by the flowchart of FIG. 13 (blocks 1330 and 1335-1340, respectively).

In some examples, the subzone boundary creation circuitry 230 includes means for receiving user edits to a boundary and/or an operation for the boundary. For example, the means for receiving user edits to the boundary and/or the operation for the boundary may be implemented by user editing interface circuitry 340. In some examples, the user editing interface circuitry 340 may be instantiated by programmable circuitry such as the example programmable circuitry 1412 of FIG. 14. For instance, the user editing interface circuitry 340 may be instantiated by the example microprocessor 1500 of FIG. 15 executing machine executable instructions such as those implemented by at least block 1330 of FIG. 13. In some examples, the user editing interface circuitry 340 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the user editing interface circuitry 340 may be instantiated by any other combination of hardware, software, and/or firmware. For example, the user editing interface circuitry 340 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the subzone boundary creation circuitry 230 includes means for editing a boundary and/or an operation for the boundary. For example, the means for editing the boundary and/or the operation for the boundary may be implemented by user editing circuitry 342. In some examples, the user editing circuitry 342 may be instantiated by programmable circuitry such as the example programmable circuitry 1412 of FIG. 14. For instance, the user editing circuitry 342 may be instantiated by the example microprocessor 1500 of FIG. 15 executing machine executable instructions such as those implemented by at least blocks 1335 and 1340 of FIG. 13. In some examples, the user editing circuitry 342 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the user editing circuitry 342 may be instantiated by any other combination of hardware, software, and/or firmware. For example, the user editing circuitry 342 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

Once edits are completed, the boundaries and machine operations are sent to the machine export circuitry 344. The machine export circuitry 344 may format the boundaries and machine operations, and send the boundaries and machine operations to a mobile or machine display. In some examples, the machine export circuitry 344 is instantiated, in part, by programmable circuitry executing machine export instructions and/or configured to perform operations such as those represented by the flowchart of FIG. 13 (block 1350).

In some examples, the subzone boundary creation circuitry 230 includes means for exporting a boundary and/or a machine operation to a machine. For example, the means for exporting the boundary and/or the machine operation to the machine may be implemented by machine export circuitry 344. In some examples, the machine export circuitry 344 may be instantiated by programmable circuitry such as the example programmable circuitry 1412 of FIG. 14. For instance, the machine export circuitry 344 may be instantiated by the example microprocessor 1500 of FIG. 15 executing machine executable instructions such as those implemented by at least block 1350 of FIG. 13. In some examples, the machine export circuitry 344 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the machine export circuitry 344 may be instantiated by any other combination of hardware, software, and/or firmware. For example, the machine export circuitry 344 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The formatted boundaries and machine operations are sent to the machine control circuitry 346. The machine control circuitry 346 may be located on the physical vehicle. The machine control circuitry 346 may measure the GPS location of the machine and the boundaries received from the machine export circuitry 344. In this example, after the machine's measured GPS location crosses over the received boundaries, the machine applies the operation for that boundary and automatically changes the associated machine settings. In this example, after the machine settings are changed the physical operation of the machine is altered. The changed physical operation may be seeding rate, travel speed, spraying rate, etc. In some examples, the machine control circuitry 346 is instantiated, in part, by programmable circuitry executing machine control instructions and/or configured to perform operations such as those represented by the flowchart of FIG. 13 (block 1360).

In some examples, the subzone boundary creation circuitry 230 includes means for controlling a machine according to a boundary and a machine operation. For example, the means for controlling the machine according to the boundary and the machine operation may be implemented by machine control circuitry 346. In some examples, the machine control circuitry 346 may be instantiated by programmable circuitry such as the example programmable circuitry 1412 of FIG. 14. For instance, the machine control circuitry 346 may be instantiated by the example microprocessor 1500 of FIG. 15 executing machine executable instructions such as those implemented by at least block 1360 of FIG. 13. In some examples, the machine control circuitry 346 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the machine control circuitry 346 may be instantiated by any other combination of hardware, software, and/or firmware. For example, the machine control circuitry 346 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the subzone boundary creation circuitry 230 of FIG. 2 is illustrated in FIG. 3, one or more of the elements, processes, and/or devices illustrated in FIG. 3 may be combined, divided, re-arranged, omitted, eliminated, and/or implemented in any other way. Further, the work plan request 302, the field data collection circuitry 308, the historic machine use database 310, the boundary database 312, the boundary entry circuitry 304, the land survey database 314, the obstacle database 316, the obstacle entry interface 306, the data collection circuitry 318, the data aggregation circuitry 320, the subzone circuitry 322, the subzone detection circuitry 324, the subzone post-processing circuitry 326, the machine operation prescription circuitry 328, the machine operation prescription database 330, the subzone boundary circuitry 332, the subzone boundary creation circuitry 334, the boundary post-processing circuitry 336, display circuitry 338, the user editing circuitry 342, the user editing entry interface circuitry 340, the machine export circuitry 344, the machine control circuitry 346, and/or, more generally, the example subzone boundary creation circuitry 230 of FIG. 3, may be implemented by hardware alone or by hardware in combination with software and/or firmware. Thus, for example, any of the work plan request 302, the field data collection circuitry 308, the historic machine use database 310, the boundary database 312, the boundary entry circuitry 304, the land survey database 314, the obstacle database 316, the obstacle entry interface 306, the data collection circuitry 318, the data aggregation circuitry 320, the subzone circuitry 322, the subzone detection circuitry 324, the subzone post-processing circuitry 326, the machine operation prescription circuitry 328, the machine operation prescription database 330, the subzone boundary circuitry 332, the subzone boundary creation circuitry 334, the boundary post-processing circuitry 336, display circuitry 338, the user editing circuitry 342, the user editing entry interface circuitry 340, the machine export circuitry 344, the machine control circuitry 346, and/or, more generally, the example subzone boundary creation circuitry 230 of FIG. 3, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example subzone boundary creation circuitry of FIG. 3 may include one or more elements, processes, and/or devices in addition to, or instead of, those illustrated in FIG. 3, and/or may include more than one of any or all of the illustrated elements, processes and devices.

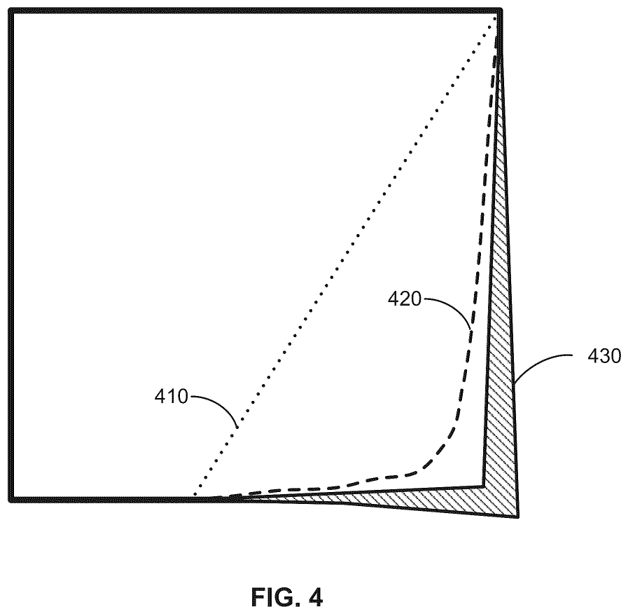

FIG. 4 is a diagram representative of different exclusion zones (410 and 420) that may be generated by the subzone boundary circuitry 230. The crosshatched area 430 represents an uncertain area of the plot of land (e.g., unsure of whether there is an obstacle present, unsure of the condition of the terrain, etc.). An area of the plot of land is uncertain when the likelihood of determining the location of objects and/or terrain in the area is below a confidence threshold. The dashed diagonal line 410 is one boundary that excludes all the area between the points of uncertainty (e.g., where the uncertain area begins, points with an uncertainty below a confidence threshold of nearly 100%, etc.). The dashed, curved line 420 is a second boundary that excludes a reduced area while ensuring the second boundary encloses an area of the plot of land with an uncertainty above the confidence threshold. For example, the curved line 420 could be generated from a set of one hundred GPS traces of vehicles traveling along the boundary with a minimum threshold of ninety-five (e.g., 95%) of the traces on the exterior side of the curved line 420. In some examples, a smoothing operation may be applied to the preliminary 95^{th} percentile boundary to generate the curved line 420. In another example, the curved line 420 could be generated from a single GNSS trace using data point quality values such as Dilution of Precision (DOP) or Circular Error Probability (CEP). The curved line 420 would be placed at a location meeting the confidence threshold based on the data point quality. In another example, the curved line 420 could be generated from remotely sensed imagery with data point quality based on pixel resolution of the data, magnitude of obscurants, accuracy of ground truth points, and other data point quality metrics. As used herein, certainty and uncertainty values are considered complementary values (e.g., in one example, a certainty value of 75% is the same as an uncertainty value of 25%, etc.).

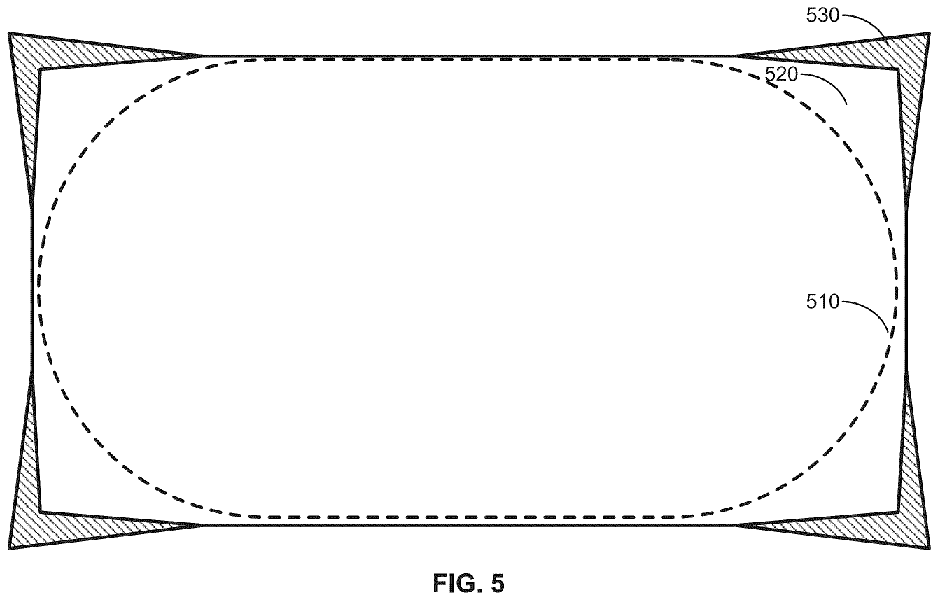

FIG. 5 is a diagram representative of an exclusion zone 510 that may be generated from the subzone boundary circuitry 230. The crosshatched area 530 represents an area of uncertainty in the in the four corners of the plot of land. The dashed line 510 represents a boundary that excludes a machine operation in the area 520 between the dashed line and the crosshatched uncertain area. The dashed line 510 (e.g., boundary) is created close to the crosshatched area 530 to ensure maximal area is included within the boundary 510. In some examples, the uncertainty 530 may be related to digitization error of a remote sensed image while in some other examples the uncertainty 530 is related to estimated GNSS receiver error.

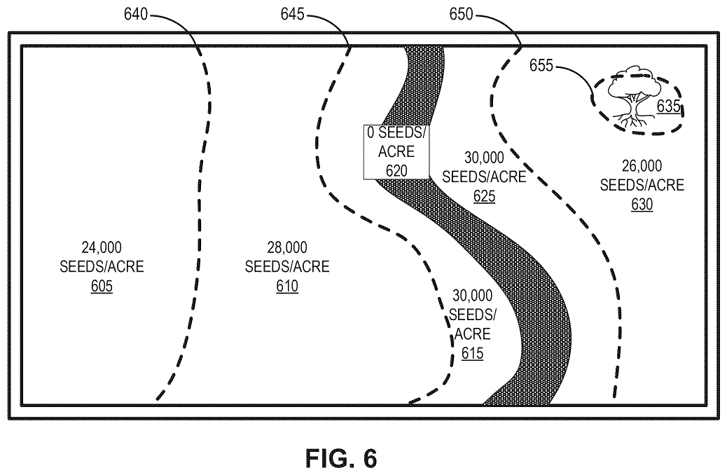

FIG. 6 is a diagram representative of different machine operations (605, 610, 615, 620, 625, 630, 635) that may be assigned to various subzones (e.g., the areas between 640, 645, 650, and 655) within a plot of land. The dashed lines between subzones (640, 645, 650, 655) may represent boundaries between the regions (e.g. clusters of data). In this example, the controlled machine operation is a seeding rate that may change per values of clusters that may correspond to soil type, soil moisture, terrain conditions, etc. In other examples, the controlled machine operation may be harvesting, sewing rate, and/or other agricultural operations. In this example, seeding does not occur in the crosshatched area 620. This crosshatched area 620 may represent a river, poor conditions, a waterway, excellent conditions, etc. Additionally, in this example, a boundary 655 is shown around a natural obstacle 635 to preclude machine operation in the area of the obstacle. Obstacles may take several forms such as trees, rocks, gravel, untraversable muddy areas, wind towers, power line poles/towers, etc.

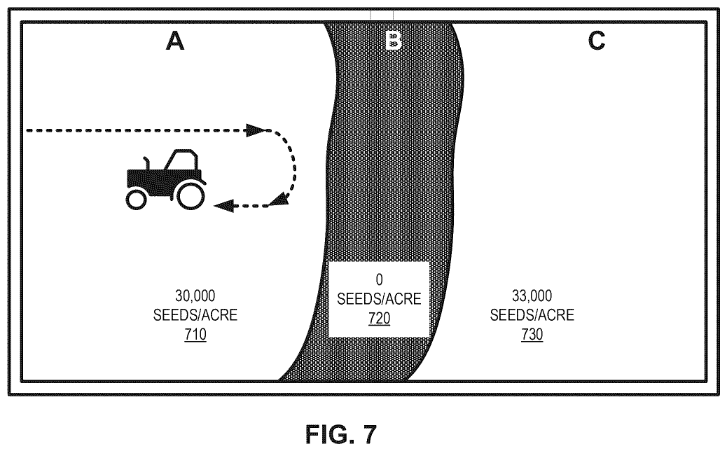

FIG. 7 is a diagram representative of an example vehicle traversing a plot of land with applied subzones and machine operations (710, 720, 730). In this example, the vehicle travels through region A 710 of the plot of land where the machine operation controls the vehicle to seed at a rate of 30,000 seeds/acre. Then, upon reaching region B 720, the vehicle is unable traverse region B and turns around. Region B 720 may represent a river, stream, waterway, gravel, rock, or other unsuitable condition for the machine operation. The region B 720 may include conditions such as poor land conditions, uncertain features, natural obstacles, unnatural hazards, a trial zone, etc. As described in connection to obstacles above, uncertain features may be present where obstacles are present in the region of the subzone, when the features of the land are unknown, or when the features of the land have changed. Additionally or alternatively, the vehicle may traverse region C 730 and change machine operations to adapt to a seeding rate of 33,000 seeds/acre. Then, upon reaching region B 720, the vehicle may turn around and traverse through region C 730.

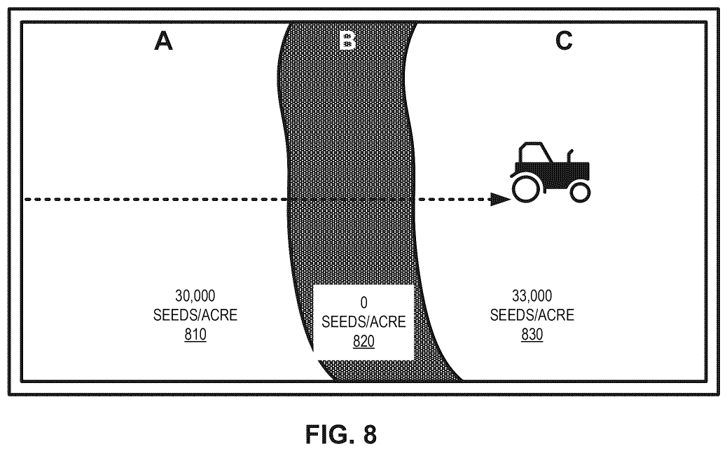

FIG. 8 is a diagram representative of an example vehicle traversing a plot of land with applied subzones and machine operations (810, 820, 830). In this example, the vehicle travels through region A 810 of the plot of land with an example machine operation of a seeding rate at 30,000 seeds/acre. Then, in region B 820 of the plot of land, the example vehicle travels with an example machine operation of a seeding rate at 0 seeds/acre. The region B 820 may include conditions such as poor land conditions, uncertain features, natural obstacles, unnatural hazards, waterway, a trial zone, etc. As opposed to FIG. 7, the vehicle traverses region B 820 but does not perform a seeding operation. Then, in region C 830, the example vehicle travels through region C of the plot of land with a machine operation of a seeding rate at 33,000 seeds/acre. Region C 830 may represent an area with excellent land conditions, soil moisture, optimal natural conditions, etc.

Flowcharts representative of example machine-readable instructions, which may be executed by programmable circuitry to implement and/or instantiate the subzone boundary creation circuitry 230 of FIG. 3 and/or representative of example operations which may be performed by programmable circuitry to implement and/or instantiate the subzone boundary creation circuitry 230 of FIG. 3, are shown in FIGS. 9-13. The machine-readable instructions may be one or more executable programs or portion(s) of one or more executable programs for execution by programmable circuitry such as the programmable circuitry 1412 shown in the example processor platform 1400 discussed below in connection with FIG. 14 and/or may be one or more function(s) or portion(s) of functions to be performed by the example programmable circuitry (e.g., an FPGA) discussed below in connection with FIGS. 15 and/or 16. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIGS. 9-13, many other methods of implementing the example subzone boundary creation may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 9-13 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 9 is a flowchart representative of example machine-readable instructions and/or example operations 900 that may be executed, instantiated, and/or performed by programmable circuitry to perform subzone boundary creation. FIG. 9 is a flowchart representing the high-level process of subzone boundary creation. The process starts at block 910 where a work plan request is received for a plot of land (e.g., field). Then, at block 920, data is retrieved that corresponds to the plot of land (e.g., field) from the user. In some examples, the data retrieved that corresponds to the plot of land may be compressed data. Then, a subzone and a value of the subzone is determined based on the data (block 930). After the determination of the subzone and the value of the subzone, machine operations (e.g., prescriptions) are prescribed based on the determined value of the subzone (block 940). Then, a boundary is generated for the subzone (block 950).

FIG. 10 is a flowchart representative of example machine-readable instructions and/or example operations 930 that may be executed, instantiated, and/or performed by programmable circuitry to perform the determination of the subzone and the value (e.g., attribute) of the subzone. Once the data is collected, the data is aggregated based on the geographic location of collection (e.g., according to georeferenced coordinates) (block 1010). Then, a first subzone is detected based on the aggregated data (block 1020). In some examples, one subzone and/or multiple subzones may be detected. The first subzone may be detected based on differing attributes of clusters of data aggregated according to the geographic location of the plot of land. In some examples, the first subzone may be detected based on a characteristic of the plot of land and/or a change in a characteristic of the plot of land. In these examples, the characteristic can include elevation, soil moisture, obstacles, excellent land conditions, geospatial location, yield, surveys, boundaries, and other land conditions. After first subzone detection, the first subzone is processed according to relevance (e.g., variance in values between neighboring subzones, comparison in a value of a subzone to standard portions of the plot of land, etc.) (block 1030). In examples where there is more than one subzone (e.g., the first subzone, a second subzone, etc.), the first subzone is processed according to relevance between the first subzone and the second subzone. Then, control returns to block 940 of FIG. 9.

FIG. 11 is a flowchart representative of example machine-readable instructions and/or example operations 1020 that may be executed, instantiated, and/or performed by programmable circuitry to perform detection of the first subzone. This process may be performed additionally or alternatively to another technique of detection of first subzone. The process begins at block 1110 where the data corresponding to the first subzone is converted into a graph. Then, community detection is performed to determine the value of clusters and objects within the plot of land to affect machine operation (block 1120). Once this process is performed, control returns to block 940 of FIG. 9. In this example, prescriptions for machine operations are generated based on detected communities (e.g., differences in values of clusters per identified subzone of the queried plot of land, etc.).

FIG. 12 is a flowchart representative of example machine-readable instructions and/or example operations 940 that may be executed, instantiated, and/or performed by programmable circuitry to perform prescription of field operations based on the determined value of the subzone. The process begins with a determination of whether there is a user prescription entered from the user (block 1210). If there is no user prescription (block 1210: NO), the process proceeds to block 1220 where a database (e.g., default) prescription is applied to the first subzone. If there is a user prescription (block 1210: YES), the process proceeds to block 1230 where the user prescription is applied to the first subzone. After the user prescriptions are applied to the first subzone, the database prescription is applied to a second subzone (block 1240). Once this process is performed, control returns to block 950 of FIG. 9.

FIG. 13 is a flowchart representative of example machine-readable instructions and/or example operations 950 that may be executed, instantiated, and/or performed by programmable circuitry to perform the generation of boundaries for each subzone. After prescriptions are applied, either user-entered or from a database, a first boundary is created around the first subzone and a second boundary is created around the second subzone (block 1310). In some examples, the first boundary is created around a first region, wherein the first region includes a first area of land including the first attribute. Further, in these examples, the second boundary is created around the first region, wherein the first region includes a second area of land including the second attribute. Once the first boundary is created around the first subzone and the second boundary is created around the second subzone, the first boundary and the second boundary are combined into a single geometric object representing the plot of land subject to the user's query (block 1320). Then, the combined boundaries are displayed to the user (block 1330). A determination is made whether the user wishes to edit the displayed boundaries (block 1340). If a user elects to make edits (block 1340: YES), the edits are received (block 1335) and control proceeds to display those edits to the user (block 1330). However, if a user selects not to edit the displayed boundaries (block 1340: NO), the boundaries are sent to the mobile (e.g., machine, interface, etc.) display (block 1350). Then, the boundaries aid to control machine operation according to the GPS location of the machine in relation to the boundaries and assigned machine prescriptions (block 1360).

FIG. 14 is a block diagram of an example programmable circuitry platform 1400 structured to execute and/or instantiate the example machine-readable instructions and/or the example operations of FIGS. 9-13 to implement the subzone boundary creation circuitry of FIG. 2. The programmable circuitry platform 1400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1400 of the illustrated example includes programmable circuitry 1412. The programmable circuitry 1412 of the illustrated example is hardware. For example, the programmable circuitry 1412 can be implemented by one or more integrated circuits, logic circuits, FPGAs, microprocessors, CPUs, GPUs, DSPs, and/or microcontrollers from any desired family or manufacturer. The programmable circuitry 1412 may be implemented by one or more semiconductor based (e.g., silicon based) devices. In this example, the programmable circuitry 1412 implements the geospatial compression circuitry 220, the subzone boundary creation circuitry 230, and the soft boundary creation circuitry 240.

The programmable circuitry 1412 of the illustrated example includes a local memory 1413 (e.g., a cache, registers, etc.). The programmable circuitry 1412 of the illustrated example is in communication with main memory 1414, 1416, which includes a volatile memory 1414 and a non-volatile memory 1416, by a bus 1418. The volatile memory 1414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1416 may be implemented by flash memory and/or any other desired type of memory device. Access to the main memory 1414, 1416 of the illustrated example is controlled by a memory controller 1417. In some examples, the memory controller 1417 may be implemented by one or more integrated circuits, logic circuits, microcontrollers from any desired family or manufacturer, or any other type of circuitry to manage the flow of data going to and from the main memory 1414, 1416.

The programmable circuitry platform 1400 of the illustrated example also includes interface circuitry 1420. The interface circuitry 1420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1422 are connected to the interface circuitry 1420. The input device(s) 1422 permit(s) a user (e.g., a human user, a machine user, etc.) to enter data and/or commands into the programmable circuitry 1412. The input device(s) 1422 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1424 are also connected to the interface circuitry 1420 of the illustrated example. The output device(s) 1424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1420 of the illustrated example, thus, typically includes a graphics driver card, a graphics driver chip, and/or graphics processor circuitry such as a GPU.

The interface circuitry 1420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1426. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1400 of the illustrated example also includes one or more mass storage discs or devices 1428 to store firmware, software, and/or data. Examples of such mass storage discs or devices 1428 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1432, which may be implemented by the machine-readable instructions of FIGS. 9-13, may be stored in the mass storage device 1428, in the volatile memory 1414, in the non-volatile memory 1416, and/or on at least one non-transitory computer-readable storage medium such as a CD or DVD which may be removable.

FIG. 15 is a block diagram of an example implementation of the programmable circuitry 1412 of FIG. 14. In this example, the programmable circuitry 1412 of FIG. 14 is implemented by a microprocessor 1500. For example, the microprocessor 1500 may be a general-purpose microprocessor (e.g., general-purpose microprocessor circuitry). The microprocessor 1500 executes some or all of the machine-readable instructions of the flowcharts of FIGS. 9-13 to effectively instantiate the circuitry of FIG. 2 as logic circuits to perform operations corresponding to those machine-readable instructions. In some such examples, the circuitry of FIG. 2 is instantiated by the hardware circuits of the microprocessor 1500 in combination with the machine-readable instructions. For example, the microprocessor 1500 may be implemented by multi-core hardware circuitry such as a CPU, a DSP, a GPU, an XPU, etc. Although it may include any number of example cores 1502 (e.g., 1 core), the microprocessor 1500 of this example is a multi-core semiconductor device including N cores. The cores 1502 of the microprocessor 1500 may operate independently or may cooperate to execute machine-readable instructions. For example, machine code corresponding to a firmware program, an embedded software program, or a software program may be executed by one of the cores 1502 or may be executed by multiple ones of the cores 1502 at the same or different times. In some examples, the machine code corresponding to the firmware program, the embedded software program, or the software program is split into threads and executed in parallel by two or more of the cores 1502. The software program may correspond to a portion or all of the machine-readable instructions and/or operations represented by the flowcharts of FIGS. 9-13.

The cores 1502 may communicate by a first example bus 1504. In some examples, the first bus 1504 may be implemented by a communication bus to effectuate communication associated with one(s) of the cores 1502. For example, the first bus 1504 may be implemented by at least one of an Inter-Integrated Circuit (I2C) bus, a Serial Peripheral Interface (SPI) bus, a PCI bus, or a PCIe bus. Additionally or alternatively, the first bus 1504 may be implemented by any other type of computing or electrical bus. The cores 1502 may obtain data, instructions, and/or signals from one or more external devices by example interface circuitry 1506. The cores 1502 may output data, instructions, and/or signals to the one or more external devices by the interface circuitry 1506. Although the cores 1502 of this example include example local memory 1520 (e.g., Level 1 (L1) cache that may be split into an L1 data cache and an L1 instruction cache), the microprocessor 1500 also includes example shared memory 1510 that may be shared by the cores (e.g., Level 2 (L2 cache)) for high-speed access to data and/or instructions. Data and/or instructions may be transferred (e.g., shared) by writing to and/or reading from the shared memory 1510. The local memory 1520 of each of the cores 1502 and the shared memory 1510 may be part of a hierarchy of storage devices including multiple levels of cache memory and the main memory (e.g., the main memory 1414, 1416 of FIG. 14). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1502 may be referred to as a CPU, DSP, GPU, etc., or any other type of hardware circuitry. Each core 1502 includes control unit circuitry 1514, arithmetic and logic (AL) circuitry (sometimes referred to as an ALU) 1516, a plurality of registers 1518, the local memory 1520, and a second example bus 1522. Other structures may be present. For example, each core 1502 may include vector unit circuitry, single instruction multiple data (SIMD) unit circuitry, load/store unit (LSU) circuitry, branch/jump unit circuitry, floating-point unit (FPU) circuitry, etc. The control unit circuitry 1514 includes semiconductor-based circuits structured to control (e.g., coordinate) data movement within the corresponding core 1502. The AL circuitry 1516 includes semiconductor-based circuits structured to perform one or more mathematic and/or logic operations on the data within the corresponding core 1502. The AL circuitry 1516 of some examples performs integer-based operations. In other examples, the AL circuitry 1516 also performs floating-point operations. In yet other examples, the AL circuitry 1516 may include first AL circuitry that performs integer-based operations and second AL circuitry that performs floating-point operations. In some examples, the AL circuitry 1516 may be referred to as an Arithmetic Logic Unit (ALU).

The registers 1518 are semiconductor-based structures to store data and/or instructions such as results of one or more of the operations performed by the AL circuitry 1516 of the corresponding core 1502. For example, the registers 1518 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1518 may be arranged in a bank as shown in FIG. 15. Alternatively, the registers 1518 may be organized in any other arrangement, format, or structure, such as by being distributed throughout the core 1502 to shorten access time. The second bus 1522 may be implemented by at least one of an I2C bus, a SPI bus, a PCI bus, or a PCIe bus.

Each core 1502 and/or, more generally, the microprocessor 1500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1500 is a semiconductor device fabricated to include many transistors interconnected to implement the structures described above in one or more integrated circuits (ICs) contained in one or more packages.

The microprocessor 1500 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1500, in the same chip package as the microprocessor 1500 and/or in one or more separate packages from the microprocessor 1500.

FIG. 16 is a block diagram of another example implementation of the programmable circuitry 1412 of FIG. 14. In this example, the programmable circuitry 1412 is implemented by FPGA circuitry 1600. For example, the FPGA circuitry 1600 may be implemented by an FPGA. The FPGA circuitry 1600 can be used, for example, to perform operations that could otherwise be performed by the example microprocessor 1500 of FIG. 15 executing corresponding machine-readable instructions. However, once configured, the FPGA circuitry 1600 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1500 of FIG. 15 described above (which is a general purpose device that may be programmed to execute some or all of the machine-readable instructions represented by the flowchart(s) of FIGS. 9-13 but whose interconnections and logic circuitry are fixed once fabricated), the FPGA circuitry 1600 of the example of FIG. 16 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 9-13. In particular, the FPGA circuitry 1600 may be thought of as an array of logic gates, interconnections, and switches. The switches can be programmed to change how the logic gates are interconnected by the interconnections, effectively forming one or more dedicated logic circuits (unless and until the FPGA circuitry 1600 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 9-13. As such, the FPGA circuitry 1600 may be configured and/or structured to effectively instantiate some or all of the operations/functions corresponding to the machine-readable instructions of the flowchart(s) of FIGS. 9-13 as dedicated logic circuits to perform the operations/functions corresponding to those software instructions in a dedicated manner analogous to an ASIC. Therefore, the FPGA circuitry 1600 may perform the operations/functions corresponding to the some or all of the machine-readable instructions of FIGS. 9-13 faster than the general-purpose microprocessor can execute the same.

In the example of FIG. 16, the FPGA circuitry 1600 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1600 of FIG. 16 may access and/or load the binary file to cause the FPGA circuitry 1600 of FIG. 16 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1600 of FIG. 16 to cause configuration and/or structuring of the FPGA circuitry 1600 of FIG. 16, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1600 of FIG. 16 may access and/or load the binary file to cause the FPGA circuitry 1600 of FIG. 16 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1600 of FIG. 16 to cause configuration and/or structuring of the FPGA circuitry 1600 of FIG. 16, or portion(s) thereof.

The FPGA circuitry 1600 of FIG. 16, includes example input/output (I/O) circuitry 1602 to obtain and/or output data to/from example configuration circuitry 1604 and/or external hardware 1606. For example, the configuration circuitry 1604 may be implemented by interface circuitry that may obtain a binary file, which may be implemented by a bit stream, data, and/or machine-readable instructions, to configure the FPGA circuitry 1600, or portion(s) thereof. In some such examples, the configuration circuitry 1604 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof. In some examples, the external hardware 1606 may be implemented by external hardware circuitry. For example, the external hardware 1606 may be implemented by the microprocessor 1500 of FIG. 15.

The FPGA circuitry 1600 also includes an array of example logic gate circuitry 1608, a plurality of example configurable interconnections 1610, and example storage circuitry 1612. The logic gate circuitry 1608 and the configurable interconnections 1610 are configurable to instantiate one or more operations/functions that may correspond to at least some of the machine-readable instructions of FIGS. 9-13 and/or other desired operations. The logic gate circuitry 1608 shown in FIG. 16 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1608 to enable configuration of the electrical structures and/or the logic gates to form circuits to perform desired operations/functions. The logic gate circuitry 1608 may include other electrical structures such as look-up tables (LUTs), registers (e.g., flip-flops or latches), multiplexers, etc.

The configurable interconnections 1610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1608 to program desired logic circuits.

The storage circuitry 1612 of the illustrated example is structured to store result(s) of the one or more of the operations performed by corresponding logic gates. The storage circuitry 1612 may be implemented by registers or the like. In the illustrated example, the storage circuitry 1612 is distributed amongst the logic gate circuitry 1608 to facilitate access and increase execution speed.

The example FPGA circuitry 1600 of FIG. 16 also includes example dedicated operations circuitry 1614. In this example, the dedicated operations circuitry 1614 includes special purpose circuitry 1616 that may be invoked to implement commonly used functions to avoid the need to program those functions in the field. Examples of such special purpose circuitry 1616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1600 may also include example general purpose programmable circuitry 1618 such as an example CPU 1620 and/or an example DSP 1622. Other general purpose programmable circuitry 1618 may additionally or alternatively be present such as a GPU, an XPU, etc., that can be programmed to perform other operations.

Although FIGS. 15 and 16 illustrate two example implementations of the programmable circuitry 1412 of FIG. 14, many other approaches are contemplated. For example, FPGA circuitry may include an on-board CPU, such as one or more of the example CPU 1620 of FIG. 15. Therefore, the programmable circuitry 1412 of FIG. 14 may additionally be implemented by combining at least the example microprocessor 1500 of FIG. 15 and the example FPGA circuitry 1600 of FIG. 16. In some such hybrid examples, one or more cores 1502 of FIG. 15 may execute a first portion of the machine-readable instructions represented by the flowchart(s) of FIGS. 9-13 to perform first operation(s)/function(s), the FPGA circuitry 1600 of FIG. 16 may be configured and/or structured to perform second operation(s)/function(s) corresponding to a second portion of the machine-readable instructions represented by the flowcharts of FIG. 9-13, and/or an ASIC may be configured and/or structured to perform third operation(s)/function(s) corresponding to a third portion of the machine-readable instructions represented by the flowcharts of FIGS. 9-13.

It should be understood that some or all of the circuitry of FIG. 2 may, thus, be instantiated at the same or different times. For example, same and/or different portion(s) of the microprocessor 1500 of FIG. 15 may be programmed to execute portion(s) of machine-readable instructions at the same and/or different times. In some examples, same and/or different portion(s) of the FPGA circuitry 1600 of FIG. 16 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1500 of FIG. 15 may execute machine-readable instructions in one or more threads executing concurrently and/or in series. In some examples, the FPGA circuitry 1600 of FIG. 16 may be configured and/or structured to carry out operations/functions concurrently and/or in series. Moreover, in some examples, some or all of the circuitry of FIG. 2 may be implemented within one or more virtual machines and/or containers executing on the microprocessor 1500 of FIG. 15.

In some examples, the programmable circuitry 1412 of FIG. 14 may be in one or more packages. For example, the microprocessor 1500 of FIG. 15 and/or the FPGA circuitry 1600 of FIG. 16 may be in one or more packages. In some examples, an XPU may be implemented by the programmable circuitry 1412 of FIG. 14, which may be in one or more packages. For example, the XPU may include a CPU (e.g., the microprocessor 1500 of FIG. 15, the CPU 1620 of FIG. 16, etc.) in one package, a DSP (e.g., the DSP 1622 of FIG. 16) in another package, a GPU in yet another package, and an FPGA (e.g., the FPGA circuitry 1600 of FIG. 16) in still yet another package.

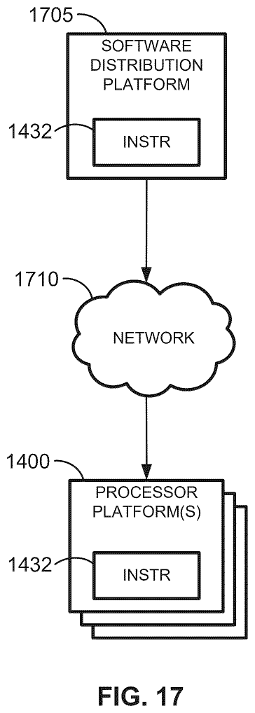

A block diagram illustrating an example software distribution platform 1705 to distribute software such as the example machine-readable instructions 1432 of FIG. 14 to other hardware devices (e.g., hardware devices owned and/or operated by third parties from the owner and/or operator of the software distribution platform) is illustrated in FIG. 17. The example software distribution platform 1705 may be implemented by any computer server, data facility, cloud service, etc., capable of storing and transmitting software to other computing devices. The third parties may be customers of the entity owning and/or operating the software distribution platform 1705. For example, the entity that owns and/or operates the software distribution platform 1705 may be a developer, a seller, and/or a licensor of software such as the example machine-readable instructions 1432 of FIG. 14. The third parties may be consumers, users, retailers, OEMs, etc., who purchase and/or license the software for use and/or re-sale and/or sub-licensing. In the illustrated example, the software distribution platform 1705 includes one or more servers and one or more storage devices. The storage devices store the machine-readable instructions 1432, which may correspond to the example machine-readable instructions of FIGS. 9-13, as described above. The one or more servers of the example software distribution platform 1705 are in communication with an example network 1710, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 1432 from the software distribution platform 1705. For example, the software, which may correspond to the example machine-readable instructions of FIG. 9-13, may be downloaded to the example programmable circuitry platform 1400, which is to execute the machine-readable instructions 1432 to implement the subzone boundary creation circuitry. In some examples, one or more servers of the software distribution platform 1705 periodically offer, transmit, and/or force updates to the software (e.g., the example machine-readable instructions 1432 of FIG. 14) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that perform subzone boundary creation to determine the travel of a vehicle. Disclosed systems, apparatus, articles of manufacture, and methods improve the efficiency of using a computing device by improving boundary creation for vehicle operation. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to perform subzone boundary creation to determine the travel of a vehicle are disclosed herein. Further examples and combinations thereof include the following:

Example 1 includes a non-transitory computer-readable medium comprising instructions which, when executed, cause processor circuitry to detect a first attribute and a second attribute based on a characteristic of a plot of land, the first attribute to correspond to an uncertain feature in the plot of land, determine a first machine operation based on the first attribute and a second machine operation based on the second attribute, determine a first boundary around a first region, the first region including a first area of the plot of land including the first attribute, determine a second boundary around a second region, the second region including a second area of the plot of land including the second attribute, and determine a work plan based on the first boundary, the second boundary, and a relevance between the first attribute and the second attribute.

Example 2 includes the non-transitory computer-readable medium of example 1, wherein the instructions are to cause the processor circuitry to control an operation of a machine, the machine to perform the first machine operation in the first region and the second machine operation in the second region.

Example 3 includes the non-transitory computer-readable medium of example 1 and example 2, wherein the first region corresponds to at least one of an uncertain area in the plot of land, an area having poor land conditions, an area having excellent land conditions, an area including an obstacle, an area having a trial zone, or an area including a hazard based on a machine operation.

Example 4 includes the non-transitory computer-readable medium of examples 1-3, wherein the characteristic of the plot of land includes geospatial location, yield, soil moisture, elevation, obstacles, land surveys, and boundaries of the plot of land.

Example 5 includes the non-transitory computer-readable medium of examples 1-4, wherein to determine the work plan based on the relevance includes at least one of to combine the first boundary and the second boundary or to remove the first boundary and the second boundary based on a difference between the first attribute, the second attribute, and a standard condition of the plot of land.

Example 6 includes the non-transitory computer-readable medium of examples 1-5, wherein detection of the first attribute and the second attribute is based on differing agronomic conditions determined by at least one of an alternative data representation, a data clustering, or a graph algorithm.

Example 7 includes the non-transitory computer-readable medium of examples 1-6, wherein the instructions are to cause the processor circuitry to receive a user edit to the first boundary and the second boundary.

Example 8 includes an apparatus to determine a boundary for a work plan, comprising display circuitry, machine-readable instructions, and programmable circuitry to at least one of instantiate or execute the machine-readable instructions to detect a first attribute and a second attribute based on a characteristic of a plot of land, the first attribute to correspond to an uncertain feature in the plot of land, determine a first machine operation based on the first attribute and a second machine operation based on the second attribute, determine a first boundary around a first region, the first region including a first area of the plot of land including the first attribute, determine a second boundary around a second region, the second region including a second area of the plot of land including the second attribute, and determine the work plan based on the first boundary, the second boundary, and a relevance between the first attribute and the second attribute.

Example 9 includes the apparatus of example 8, wherein the machine-readable instructions are to cause the programmable circuitry to control a machine based on the first boundary and the second boundary, the machine to perform the first machine operation in the first region and the second machine operation in the second region.

Example 10 includes the apparatus of example 8 and example 9, wherein the first region corresponds to at least one of an uncertain area in the plot of land, an area having poor land conditions, an area including an obstacle, an area having a trial zone, or an area including a hazard based on a machine operation.

Example 11 includes the apparatus of examples 8-10, wherein the characteristic of the plot of land includes geospatial location, yield, soil moisture, elevation, obstacles, surveys, and boundaries.

Example 12 includes the apparatus of examples 8-11, wherein to determine the work plan based on the relevance includes at least one of to combine the first boundary and the second boundary or to remove the first boundary and the second boundary based on a difference between the first attribute, the second attribute, and a standard condition of the plot of land.

Example 13 includes the apparatus of examples 8-12, wherein detection of the first attribute and the second attribute is based on differing agronomic conditions determined by at least one of an alternative data representation, a data clustering, or a graph algorithm.

Example 14 includes the apparatus of examples 8-13, wherein the programmable circuitry is to receive a user edit to the first boundary and the second boundary.

Example 15 includes a method to determine a boundary for a work plan, comprising detecting a first attribute and a second attribute based on a characteristic of a plot of land, the first attribute to correspond to an uncertain feature in the plot of land, determining a first machine operation based on the first attribute and a second machine operation based on the second attribute, determining a first boundary around a first region, the first region including a first area of the plot of land including the first attribute, determining a second boundary around a second region, the second region including a second area of the plot of land including the second attribute, and determining the work plan based on the first boundary, the second boundary, and a relevance between the first attribute and the second attribute.

Example 16 includes the method of example 15, further including controlling a machine based on the first boundary and the second boundary, the machine to perform the first machine operation in the first region and the second machine operation in the second region.

Example 17 includes the method of example 15 and example 16, wherein the first region corresponds to at least one of an uncertain area in the plot of land, an area having poor land conditions, an area having excellent land conditions, an area including an obstacle, an area having a trial zone, or an area including a hazard based on a machine operation.

Example 18 includes the method of examples 15-17, wherein the characteristic of the plot of land includes geospatial location, yield, soil moisture, elevation, obstacles, land surveys, and boundaries of the plot of land.

Example 19 includes the method of examples 15-18, wherein determining the work plan based on the relevance further includes at least one of combining the first boundary and the second boundary or removing the first boundary and the second boundary based on a difference between the first attribute, the second attribute, and a standard condition of the plot of land.

Example 20 includes the method of examples 15-19, wherein detecting the first attribute and the second attribute is based on differing agronomic conditions determined by at least one of an alternative data representation, a data clustering, or a graph algorithm.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A non-transitory computer-readable medium comprising instructions which, when executed, cause processor circuitry to:
detect a first attribute and a second attribute based on a characteristic of a plot of land, the first attribute to correspond to an uncertain feature in the plot of land;
determine a first machine operation based on the first attribute and a second machine operation based on the second attribute;
determine a first boundary around a first region, the first region including a first area of the plot of land including the first attribute;
determine a second boundary around a second region, the second region including a second area of the plot of land including the second attribute; and
determine a work plan based on the first boundary, the second boundary, and a relevance between the first attribute and the second attribute.

2. The non-transitory computer-readable medium of claim 1, wherein the instructions are to cause the processor circuitry to control an operation of a machine, the machine to perform the first machine operation in the first region and the second machine operation in the second region.

3. The non-transitory computer-readable medium of claim 1, wherein the first region corresponds to at least one of an uncertain area in the plot of land, an area having poor land conditions, an area having excellent land conditions, an area including an obstacle, an area having a trial zone, or an area including a hazard based on a machine operation.

4. The non-transitory computer-readable medium of claim 1, wherein the characteristic of the plot of land includes geospatial location, yield, soil moisture, elevation, obstacles, land surveys, and boundaries of the plot of land.

5. The non-transitory computer-readable medium of claim 1, wherein to determine the work plan based on the relevance includes at least one of to combine the first boundary and the second boundary or to remove the first boundary and the second boundary based on a difference between the first attribute, the second attribute, and a standard condition of the plot of land.

6. The non-transitory computer-readable medium of claim 1, wherein detection of the first attribute and the second attribute is based on differing agronomic conditions determined by at least one of an alternative data representation, a data clustering, or a graph algorithm.

7. The non-transitory computer-readable medium of claim 1, wherein the instructions are to cause the processor circuitry to receive a user edit to the first boundary and the second boundary.

8. An apparatus to determine a boundary for a work plan, comprising:
display circuitry;
machine-readable instructions; and
programmable circuitry to at least one of instantiate or execute the machine-readable instructions to:
detect a first attribute and a second attribute based on a characteristic of a plot of land, the first attribute to correspond to an uncertain feature in the plot of land;
determine a first machine operation based on the first attribute and a second machine operation based on the second attribute;
determine a first boundary around a first region, the first region including a first area of the plot of land including the first attribute;
determine a second boundary around a second region, the second region including a second area of the plot of land including the second attribute; and
determine the work plan based on the first boundary, the second boundary, and a relevance between the first attribute and the second attribute.

9. The apparatus of claim 8, wherein the machine-readable instructions are to cause the programmable circuitry to control a machine based on the first boundary and the second boundary, the machine to perform the first machine operation in the first region and the second machine operation in the second region.

10. The apparatus of claim 8, wherein the first region corresponds to at least one of an uncertain area in the plot of land, an area having poor land conditions, an area including an obstacle, an area having a trial zone, or an area including a hazard based on a machine operation.

11. The apparatus of claim 8, wherein the characteristic of the plot of land includes geospatial location, yield, soil moisture, elevation, obstacles, surveys, and boundaries.

12. The apparatus of claim 8, wherein to determine the work plan based on the relevance includes at least one of to combine the first boundary and the second boundary or to remove the first boundary and the second boundary based on a difference between the first attribute, the second attribute, and a standard condition of the plot of land.

13. The apparatus of claim 8, wherein detection of the first attribute and the second attribute is based on differing agronomic conditions determined by at least one of an alternative data representation, a data clustering, or a graph algorithm.

14. The apparatus of claim 8, wherein the programmable circuitry is to receive a user edit to the first boundary and the second boundary.

15. A method to determine a boundary for a work plan, comprising:
detecting a first attribute and a second attribute based on a characteristic of a plot of land, the first attribute to correspond to an uncertain feature in the plot of land;
determining a first machine operation based on the first attribute and a second machine operation based on the second attribute;
determining a first boundary around a first region, the first region including a first area of the plot of land including the first attribute;
determining a second boundary around a second region, the second region including a second area of the plot of land including the second attribute; and
determining the work plan based on the first boundary, the second boundary, and a relevance between the first attribute and the second attribute.

16. The method of claim 15, further including controlling a machine based on the first boundary and the second boundary, the machine to perform the first machine operation in the first region and the second machine operation in the second region.

17. The method of claim 15, wherein the first region corresponds to at least one of an uncertain area in the plot of land, an area having poor land conditions, an area having excellent land conditions, an area including an obstacle, an area having a trial zone, or an area including a hazard based on a machine operation.

18. The method of claim 15, wherein the characteristic of the plot of land includes geospatial location, yield, soil moisture, elevation, obstacles, land surveys, and boundaries of the plot of land.

19. The method of claim 15, wherein determining the work plan based on the relevance further includes at least one of combining the first boundary and the second boundary or removing the first boundary and the second boundary based on a difference between the first attribute, the second attribute, and a standard condition of the plot of land.

20. The method of claim 15, wherein detecting the first attribute and the second attribute is based on differing agronomic conditions determined by at least one of an alternative data representation, a data clustering, or a graph algorithm.
